(19) United States
(12) Patent Application Publication
(10) Pub. No.: US 2012/0143773 A1
(43) Pub. Date: Jun. 7, 2012

(54) NOTIFICATION METHOD FOR WARRANTY MAINTENANCE SERVICE

(76) Inventor: Ejner Clausen, Lille-Skensved (DK)

(21) Appl. No.: 12/959,544

(22) Filed: Dec. 3, 2010

(51) Int. Cl. G06Q 10/00

(52) U.S. Cl. 705/302; 705/305

(57) ABSTRACT

The present invention relates to a method for recording and reminding of warranty and maintenance service relating to items purchased by a customer. More specifically the method relates to a method where data about the warranty and the maintenance service is entered and stored in a data storage system comprising a data processing program which is able to process the data in several steps and notify a service provider when maintenance service is required.

### FIELD OF THE INVENTION

The present invention relates to a method for recording and reminding of warranty and maintenance service relating to items purchased by a customer. More specifically the method relates to a method where data about the warranty and the maintenance service is stored in a data storage system comprising a data processing program which is able to process the data and notify a service provider when maintenance service is required.

### BACKGROUND OF THE INVENTION

When a customer purchases an item he normally receives a proof of purchase and additionally a warranty having a certain duration and scope. Under the warranty the manufacturer or seller typical undertakes the obligation to repair or replace the item in case of a failure of the item, which is within the duration and scope of the warranty. However, the scope of the warranty may prescribe that the item is regularly maintained. This may e.g. be the case if the item is a motorcar, a kitchen machine or an office machine such as a printer or a copy machine. The item may also be a service, such a plumbing, electrical installation and building or construction work. Such services may comprise a warranty of several years. The maintenance service may be at the expense of either the purchaser or the manufacturer or seller depending on the conditions of the warranty. If the item e.g. is a motorcar the maintenance service is normally paid by the purchaser and the conditions of the warranty may require that a maintenance service is carried out at least once a year to keep the warranty, which may have duration of several year. Normally, it is the responsibility of the purchaser that the conditions in a warranty of regular maintenance service of the purchased item are meet. Consequently, it is the burden of the purchaser to remember the regular maintenance service. If the purchaser forgets the maintenance service the warranty may be lost.

However, methods have been developed that are capable of notifying a purchaser of expiry of a warranty.

Such a method is e.g. disclosed in U.S. 2002/0026395 A1 (Peterson), which discloses a warranty tracking system, which can be incorporated in already existing personal financial software programs and allow posting and retrieval of any warranty or any guarantee associated with any product or service purchased by a consumer.

Another U.S. patent application publication U.S. 2004/0215484 A1 (McKnight et al.) discloses a slightly more sophisticated method. The method is intended for offering extension of a warranty for a first good by purchasing additional related goods, e.g. a software program. According to the method the purchaser is reminded of the expiry of warranty for the first good and offered an extension of the warranty by purchasing one or more related additional goods.

However, none of the above cited methods involves maintenance service or discuss the problems arising in respect of warranty and the need for regular maintenance service of a purchased item. Consequently, there is need for overcoming the drawbacks relating to the warranty and demand for maintenance service.

### SUMMARY OF THE INVENTION

In one aspect of the present invention a method is provided for recording and reminding of warranty and maintenance service relating to items purchased by a customer in a data storage system, said method comprising the steps of: a) creating the customers personal interface for data entry into the data storage system; b) storing information about warranty and maintenance service of one or more items in the data storage system via the data entry mechanism; c) allowing a data processing program in the data storage system to process the data about warranty and maintenance service entered into the data storage system; and d) letting the data storage system notify a service provider about maintenance service.

Consequently, the present invention relates to a method of notifying about warranty and maintenance service for items purchased by a customer. The method utilizes a data storage system, which may be a computer, a server or other data processing equipment. Preferably the data storage system is a central unit with suitable backup systems.

The customer's personal interface for data entry into the data storage system may simply be an Internet connection with personal code. The data may in such an embodiment be entered into the data storage system from the customer's personal computer via the internet. However, other ways of transmitting data may be usable, such as using the telephone line or wireless transmission.

Once the personal interface has been created, data for the purchase of an item can be stored in the data storage system, e.g. uploaded from the customer's personal computer to the data storage system. The data may be proof of purchase, such as an invoice or receipt, warranty or certificate of guarantee, manual etc. The pages containing the proof of purchase, warranty etc. may be scanned and uploaded to the data storage system. In one embodiment the data storage system is able to read and process the data from scanned pages and, thereby, calculate the desired time limits for notification. Alternatively, the data about expiry of warranty and regular maintenance service may be feed into the data storage system via the keyboard of e.g. a personal computer, cell phone or PDA. The data may also be provided to the customer on a smart card which can be inserted in a card reader from which the data can be uploaded. The data may also comprise an extended warranty, which may be acquired for an item by additional payment. The warranty may also be an insurance that have been bought in connection with the item.

The data storage system comprises a data processing program that is capable of processing the data entered into the system and calculate the time limits for regular maintenance service and expiry of the warranty. Thus, the system can use the entered data to calculate time limits and based on the calculation notify a service provider that an item needs maintenance service. The service provider may then contact the customer that has purchased the item and perform the required maintenance service. This is a very helpful method for the customer that ensures that the customer can make advantage of the warranty and/or insurance in the entire duration.

According to the method the service provider is selected in accordance with the data entered into the data storage system. The data processing program comprised in the data storage system may, thus, select the service provider based on the date entered into the system by the customer or, alternatively, the system may select a service provider from a data base. The latter selection may involve distance between the customer and the service provider, delivery time for maintenance service etc.

The method according to the invention may comprise the further step of letting the data storage system remind the customer about time limits of expiry of warranty and maintenance service. Such a reminder may very helpful for the customer and can be delivered as e.g. an email via the Internet or as a SMS over the cell phone.

In an embodiment of the method the customer's personal interface for data entry into the data storage system is an account in the data storage system. A personal interface having the form of an account is very useful as it makes it possible to organize the data for an item, such as the data of purchase, warranty and maintenance service.

Such a personal interface having the form or an account also makes it possible that data for warranty and maintenance service for several different items can be entered and processed by the processing program in the data storage system. Moreover, it will also allow the data storage system to notify several different service providers, which may perform maintenance service on several different items purchased by the customer.

The method according to the invention also provides an embodiment where further data about a purchased item may be entered into the data storage system subsequently. In this manner it is possible to keep the data about a purchased item updated and add extra information if desired, e.g. a later purchase of an insurance that extend the warranty of the item.

In an embodiment of the method the date storage system may further comprise a payment function. A payment function makes it possible for the customer to pay for services from the data storage system in an easy manner, e.g. online by use of credit card. It may also make it possible for a service provider after a payment to enter a list of service providers in the data storage system.

In a further aspect the present invention relates to method of recording and reminding of maintenance service relating to one or more items purchased by a customer in a data storage system, said method comprising the steps of: a) creating the customers personal interface for data entry into the data storage system; b) storing information about maintenance service of one or more items in the storage system via the data entry mechanism; c) allowing a data processing program in the data storage system to process the data about maintenance service entered into the data storage system; and d) letting the data storage system notify a service provider about maintenance service.

The method provides a possibility for a customer to store information about maintenance service for a purchased item in the data storage system which will process the data and in due time notify a service provider that maintenance service of the item is required. In this manner the customer do not have to remember the due time for maintenance service, which may be important for the warranty and the service life of the item.

Accordingly the method comprises the further step of letting the service provider notify the customer that maintenance service of the purchased item is required. In connection with the notification the service provider may arrange where and when the maintenance service is to be performed. In this manner the method provides a solution which is very advantageous for the customer and the service provider.

In the context of the present invention maintenance service may be an inspection or a service check e.g. for a car or kitchen machine, however, it may also be an update of software in e.g. a cell phone or a computer.

In an embodiment of the method the service provider is notified about maintenance service before the expiration of an optional warranty period. In this embodiment the service provider may find faults in the item that can be repaired under the warranty, whereby the customer can save the money for the repair.

As the method provides many beneficial features and services, the method also comprises an embodiment where the customer or the service provider or both may pay for services from the data storage system.

### BRIEF DESCRIPTION OF THE DRAWINGS

The invention will be described in more details with reference to some embodiments and a drawing in which:

FIG. 1 is a flowchart that schematically illustrates one embodiment of the invention;

FIG. 2 is a flowchart that schematically illustrates an alternative embodiment of the invention.

### DESCRIPTION OF PREFERRED EMBODIMENTS

Illustrative embodiments of the method according to the invention are described below. In the context of this application the term “item” should be understood in a very broad sense, and comprises goods, such as phones, televisions, cars, furniture, kitchen machines etc, but also software programs and services such a plumbing, building and construction work. Thus, “item” is to be understood as any goods or services that comprise a warranty and/or require maintenance service.

The maintenance service may comprise and inspection and optional required actions for maintenance, e.g. adjustment or lubrication. An inspection may be an inspection of e.g. rust protection of an item to confirm whether or not the rust protection is damaged and requires repairing. However, the maintenance service may also comprise a repairment of the item, e.g. by repairing or replacing one or more parts in the item that have failed. Such parts may be repaired or replaced under a warranty.

A warranty may be a warranty that is given in connection with the purchase of an item, or a warranty or insurance that is acquired for an additional payment at the time of purchase or at a later time.

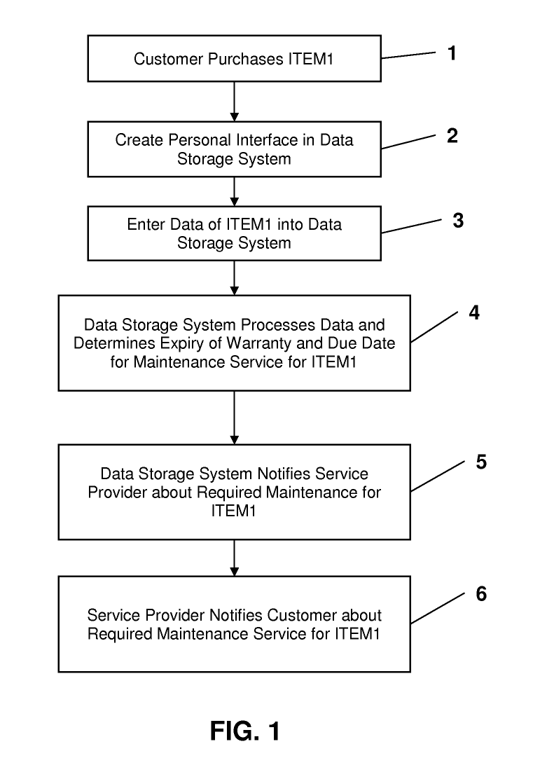

In FIG. 1 one embodiment of the method is illustrated. Box 1 illustrates that the customer purchases an item which are denoted as item 1. Item 1 comprises a warranty, which in case of item 1 is dependent on that maintenance service is performed at a regular basis. Thus, the customer wishes to make use of the services according to the method and in box 2 the customer create his personal interface in the data storage system. In this embodiment the customer creates his personal interface on a home page on the internet (i.e. the homepage of the data storage system), where he opens an account in the data storage system. The data storage system will provide the customer with personal codes to get access to the account.

When the account has been opened, the customer can enter the data of item 1 into the data storage system, which is illustrated in box 3. The data can be entered as a posting in the account. After the account has been opened it is possible to enter data about more items, and in principle data about as many items as you like. The data storage system will then process the data about each item. The data can be entered into the account by using the keyboard of a personal computer or they can be entered electronically by using a smart card or by transferring data about the item from a database created by the seller as a service to the customer. It will also be possible to scan papers related to item 1 and store them in the account. Such papers can e.g. be proof of purchase, warranty, user's manual etc.

As illustrated in box 4 the data storage system process the data of item 1 and calculates the expiry date of the warranty and the last due date for maintenance service. In case the item needs regular maintenance service the date storage system will calculate all the dates for future maintenance service, at least for a period that is expected to be the service time of the item. The data storage system uses a suitable software program to calculate the dates. Such a software program can easily be created and adapted by a skilled person for the purpose of the data storage system.

The data storage system will at a date, which is at a predetermined time, e.g. one or two months, before the due date for maintenance service, notify a service provider that maintenance service for item 1 is required as shown in box 5. The name and address of the service provider is entered into the account in the data storage system, which allows the system to find the service provider and notify him. The data storage system may notify the service provider electronically, e.g. by SMS, email or by other suitable electronically notification systems. Alternatively, the data storage system may notify the service provider by mail, e.g. by sending a letter.

The embodiment illustrated in FIG. 1 may further comprise a feature wherein the service provider confirms that he has received the notification. In case the data storage system does not receive a confirmation from the service provider within a predetermined time it will send the notification to the service provider once more. The data storage system will subsequently continue to send reminders with shorter and shorter time intervals to the service provider until the service provider confirms receipt of the notification.

When the service provider has received the notification from the data storage system he will, as illustrated in box 6, notify the customer about the required maintenance service for item 1 and make an agreement with the customer of where and when to perform the maintenance service. The maintenance should of course be performed before the due date determined by the conditions of the warranty.

The method may comprise the additional feature that the service provider keeps on sending notifications and reminders to the customer until the customer responds and confirms receipt of the notification about maintenance service. The service provider may notify the customer electronically, e.g. by SMS, email or by other suitable electronically notification systems. The service provider may also call the customer over the phone to make the notification. Alternatively, the service provider may notify the customer by mail, e.g. by sending a letter.

Thus, once the customer has entered the data about item 1 in the data storage system he does not have to remember or take any actions in respect of maintenance service to keep the warranty. The data storage system will perform the required actions to maintain the warranty.

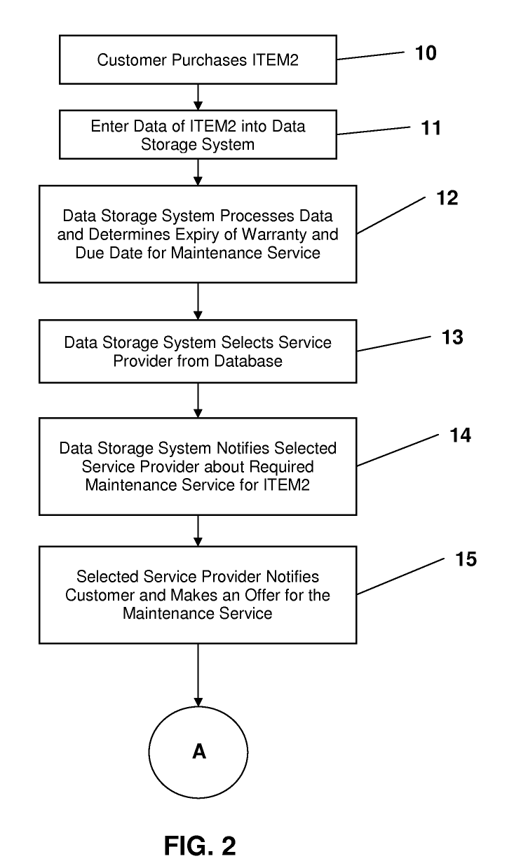

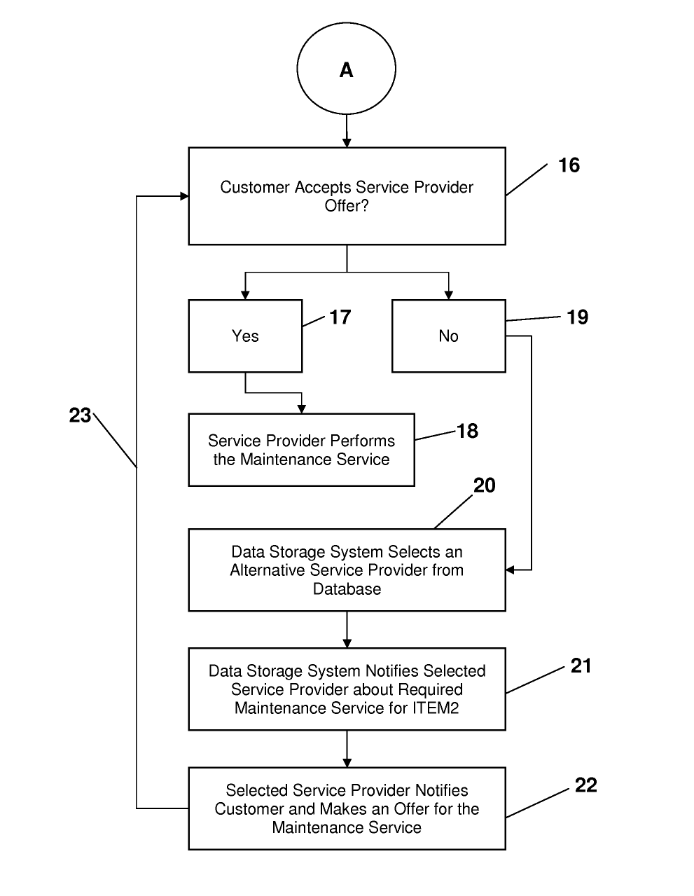

FIG. 2 illustrates an alternative embodiment of the method according to the invention. In this embodiment it is presupposed that the customer has already created an account in the data storage system.

Consequently, when the customer purchases item 2 as shown in box 10 he can immediately enter the data for item 2 into the account in the data storage system as a new posting, which is illustrated in box 11 of FIG. 2.

As schematically shown in box 12 the data storage system will process the entered data for item 2 by means of a suitable software program and calculate the expiry date of the warranty and the due date for the maintenance service, and optionally the subsequent due dates for regular maintenance service.

In this particular embodiment the data storage system will select a service provider for the maintenance service of item 2 as seen in box 13. The data storage system will select the service provider in a data base and will use criteria for the selection, such as the service provider's competence, distance from customer, delivery time, price etc. The selection will be made at a predetermined time before the due date for maintenance service, e.g. two or three months before the due date.

When the data storage system has selected the service provider about the required maintenance service for item 2 as illustrated in box 14, the service provider will, as shown in box 15, notify the customer about the required maintenance service for item 2 and at the same time make an offer for the maintenance service.

As illustrated in box 16, the customer now has to accept or refuse the offer made by the service provider, If the customer accepts the offer (box 17) the service provider will perform the maintenance service in accordance with the offer and the conditions of the warranty as shown in box 18

However, if the customer refuses the offer made by the selected service provider (box 19), the date storage system will now select an alternative or second service provider from the data base using the same criteria as above, but excluding the first selected service provider. This process is schematically illustrated in box 20.

When the data storage system has selected the second service provider, the system notifies the second service provider about the required maintenance service for item 2 as illustrated in box 21 of the flow sheet.

In accordance with the method of the present invention and illustrated in box 22, the second service provider now notifies the customer and makes and offer for the maintenance service of item 2.

As indicated by line 23 the procedure will now follow the same steps as illustrated in box 16-20 in FIG. 2. This means that the customer has to accept or refuse the offer made by the second service provider.

In case the customer accepts the offer, the second service provider will perform the maintenance service. However, if the customer refuses the offer the data storage system will select yet another service provider. This loop can in principle continue as long as the customer refuses the service provider selected by the data storage system. However, for practical reasons, i.e. the maintenance service has to be performed before the due date the possible number of loops and selection of alternative service providers may be restricted to three or four.

Thus, the above described embodiments offer a very advantageous solution to the customer for surveillance of expiry of warranties for items purchased by the customer and, furthermore, the method will ensure that the necessary actions to maintain the warranty are taken. Moreover, the method according to the invention will also have a positive influence on the service time and function of the item as the method ensures that the required maintenance service is performed in due time.

The method according to the invention and the embodiments described above may include the further step that the customer makes a payment to the data storage system to receive the services offered by the system. In particular the second embodiment described with reference to FIG. 2 may include a step where the service providers make a payment to the system to enter the data base of service providers.

Although the method according to the present invention has been described with reference to only a few embodiments, it can easily be envisaged that several other embodiments can be provided within the scope of the present invention as defined in the claims.

1. A method for recording and reminding of warranty and maintenance service relating to items purchased by a customer in a data storage system, said method comprising the steps of:
a) creating the customers personal interface for data entry into the data storage system;
b) storing information about warranty and maintenance service of one or more items in the data storage system via the data entry mechanism;
c) allowing a data processing program in the data storage system to process the data about warranty and maintenance service entered into the data storage system; and
d) letting the data storage system notify a service provider about maintenance service.

2. The method according to claim 1, wherein the method comprises the further step of letting the data storage system remind the customer about time limits of warranty and maintenance service.

3. The method according to claim 1, wherein the service provider is selected in accordance with the data entered into the data storage system.

4. The method according to claim 1, wherein the customer's personal interface for data entry into the data storage system is an account in the data storage system.

5. The method according to claim 1, wherein data for warranty and maintenance service for several different items are entered and processed by the processing program in the data storage system allowing the data storage system to notify several different service providers.

6. The method according to claim 1, wherein further data about a purchased item may be entered into the data storage system subsequently.

7. The method according to claim 1, wherein the date storage system further comprises a payment function.

8. A method for recording and reminding of maintenance service relating to one or more items purchased by a customer in a data storage system, said method comprising the steps of:
a) creating the customers personal interface for data entry into the data storage system;
b) storing information about maintenance service of one or more items in the storage system via the data entry mechanism;
c) allowing a data processing program in the data storage system to process the data about maintenance service entered into the data storage system; and
d) letting the data storage system notify a service provider about maintenance service.

9. The method according to claim 8, comprising the further step of letting the service provider notify the customer that maintenance service of the purchased item is required.

10. The method according to claim 8, wherein the service provider is notified about maintenance service before the expiration of an optional warranty period.
